(19) United States
(12) Patent Application Publication
(10) Pub. No.: US 2013/0098896 A1
(43) Pub. Date: Apr. 25, 2013

(54) Heater Rod Comprising a Casing in Which at Least One Electrical Resistance Heating Element is Mounted

(71) Applicants: Christian Schott, Neuilly sur Marne (FR); Jacques Toussaint, Neuilly sur Marne (FR)

(72) Inventors: Christian Schott, Neuilly sur Marne (FR); Jacques Toussaint, Neuilly sur Marne (FR)

(73) Assignee: VULCANIC, Neuilly sur Marne (FR)

(21) Appl. No.: 13/806,867

(22) PCT Filed: Jun. 28, 2011
(86) PCT No.: PCT/FR2011/051501

§ 371 Date: Dec. 26, 2012

(30) Foreign Application Priority Data
Jul. 1, 2010 (FR) 1002793

(51) Int. Cl. H05B 3/44; H01C 17/02

(52) U.S. Cl. CPC H05B 3/44; H01C 17/02
USPC 219/534; 219/542; 29/611

(57) ABSTRACT

A heater rod has a casing in which at least one electrical resistance heating element is mounted, an internai insulator being placed in the casing to ensure thermal conduction and electrical insulation between the resistance element and the casing, the resistance element being formed from at least one heating wire having a helical geometry and the internai insulator being based on boron nitride.

### BACKGROUND

The invention relates to a heater rod comprising a casing wherein at least one electrical resistance heating element is mounted, as well as a method for carrying out such a heater rod.

Such rods are used to heat solids or fluids in the industrial field. They have applications in particular in electricity producing nuclear power plants, where they are used to heat boron water pressurisers in the primary circuit of the reactor. These rods must satisfy stringent specifications in terms of lifespan, resistance to pressure and to temperature. Furthermore, they must be able to dissipate a high thermal power in a limited volume, as for example in the tank of a primary circuit pressuriser, and therefore have a high rate of thermal emission, generally higher than 16 W/cm2.

These rods have a cylindrical metal casing commonly referred to as shielding, heating wires mounted in said casing and an internal insulator in order to ensure the thermal conduction and electrical insulation between said heating wires and said casing.

According to an industrial embodiment, the electrical heating rods can be provided with an internal insulator of the “electrofused magnesia” (MgO) type. Furthermore, there are heater rods which are carried out by threading rectilinear heating wires into a barrel of an internal insulator with a compressed material base, in such a way that said heating wires are placed in a squirrel cage in said rods.

### SUMMARY OF THE INVENTION

The invention aims to improve the prior art by proposing in particular heater rods that have both a long lifespan and low sensitivity to mechanical stresses.

For this purpose, according to a first aspect, the invention proposes a heater rod comprising a casing wherein at least one electrical resistance heating element is mounted, an internal insulator being placed in the casing in order to ensure the thermal conduction and the electrical insulation between said resistance and said casing, with the resistance being formed of at least one heating wire which has a helical geometry and the internal insulator has a boron nitride base.

According to a second aspect, the invention proposes a method for carrying out such a heater rod, said method providing to:
place at least one electrical resistance heating element formed of at least one heating wire having a helical geometry in a casing;
place an internal insulator with a boron nitride base in said casing;
compact the whole.

### BRIEF DESCRIPTION OF THE DRAWINGS

Other particularities and advantages of the invention shall appear in the following description, made in reference to the annexed figures wherein:

FIG. 1 diagrammatically shows a heater rod according to an embodiment of the invention;

FIG. 2 shows an enlargement of the zone II of FIG. 1.

### DETAILED DESCRIPTION OF THE PREFERRED EMBODIMENT(S)

In relation with these figures, a heater rod is described hereinbelow comprising a casing 1 which can be made of metal and have a cylindrical shape.

This casing 1 is terminated by an end 2 which is fixed to the casing 1 by welding or brazing. Furthermore, the casing 1 is fixed by welding or brazing on the head of a sealed electrical connector 3 which provides for the passage of an electric current between the interior and the exterior of the heater rod.

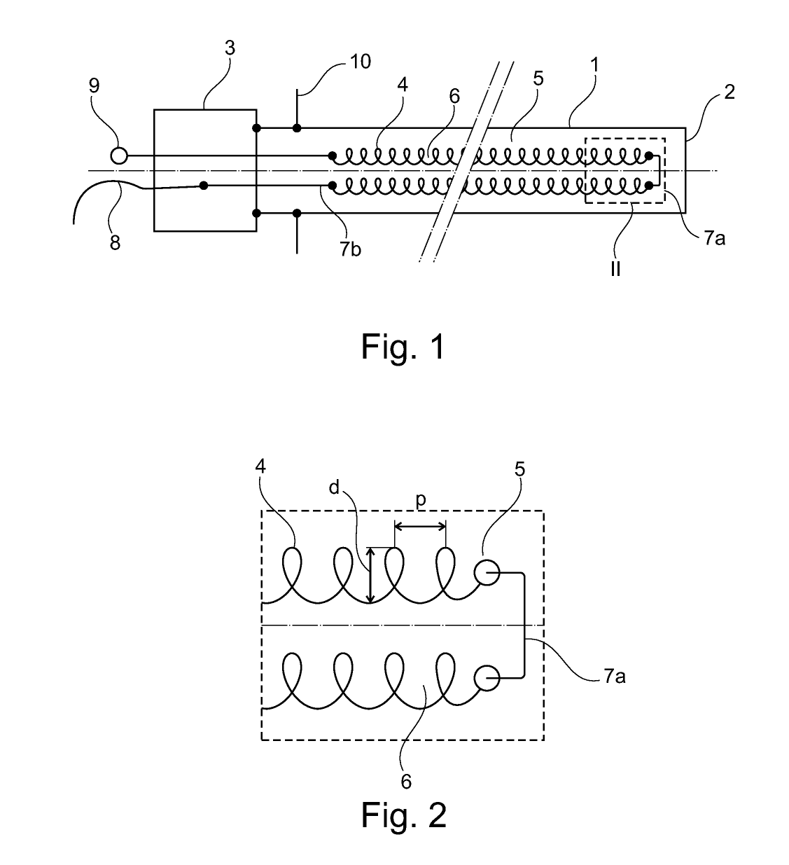

In relation with FIG. 1, a part 10 can be fixed by welding or brazing and in a sealed manner on the connector 3 of the heater rod, in order to allow for the sealed fastening of said rod on its receptacle.

The casing 1, the end 2, the connector 3 and the welds and brazes for fastening these elements together are designed and controlled in order to resist without damage the stresses of the receptacle equipment whereon the heater rod is installed, in particular in terms of pressure, temperature, corrosion and radiation.

At least one electrical resistance heating element 4 is mounted in the casing 1. The resistance 4 is formed of at least one heating wire which has a helical geometry. In relation with FIG. 2, the helical geometry of the heating wire is defined by a winding diameter d and by a spire pitch p. This geometry is particularly advantageous for a heater rod intended to be subjected to alternating temperature cycles.

Furthermore, the heating wire can be made of nickel/chrome, in order to withstand high temperatures and to not modify its dissipating power during variations in temperature.

An internal insulator 5 is placed in the casing 1 in order to ensure the thermal conduction and the electrical insulation between the resistance 4 and said casing. The internal insulator 5 has a boron nitride base, a material that has in particular a substantial thermal conduction coefficient, in order to be able to subject the heating wire of the resistance 4 to lower temperatures and as such increase the lifespan and/or the rate of thermal emission of said heating wire.

According to an embodiment, the heater rod is carried out by placing at least one electrical resistance heating element 4 formed of at least one heating wire having a helical geometry in the casing 1, then by placing an internal insulator 5 with a boron nitride base in said casing.

In particular, the method for carrying out can provide to place the internal insulator 5 in the casing 1 by pouring said insulator into said casing maintained vertically. However, in light of the sticky nature of the boron nitride, the internal insulator 5 can have the form of pellets of boron nitride compressed beforehand.

Once at least one resistance 4 and an internal insulator 5 such as described hereinabove have been placed in the casing 1, the method for carrying out provides to compact the whole formed by said casing, said resistance and said internal insulator in order to obtain a heater rod. This compacting can be carried out by shrinking, rolling or drawing the casing 1.

Furthermore, in order to simplify the method for carrying out the heater rod and in order to further reduce the sensitivity of said rod to the mechanical stresses, the heating wire of the resistance 4 can be fitted as a helicoid around an insulating insert 6 before it is placed in the casing 1, in such a way that the helicoid of said heating wire extends around said insert in the heater rod.

According to an embodiment, the insulating insert 6 can be made from an insulating material base which is different from that of the internal insulator 5. For example, the insulating insert 6 can be made from a ceramic or magnesia base.

Furthermore, in order to simplify the method for carrying out the heater rod, the geometry of the heating wire of the resistance 4 is judiciously chosen. In particular, when the heating wire is not maintained at its centre by an insulating insert which it uses as support, it must have a large diameter and a helical geometry with a small winding diameter d and a large spire pitch p. As such, the shape of the heating wires and their arrangement in the casing 1 are chosen so that said wires can support the stresses due to the thermal dilatations and to the mechanical stresses to which the rod is subjected during the method of carrying out, then during its operation in situ.

In order to improve the rate of thermal emission of the heater rod, the number of heating resistances 4 and their arrangement in the casing 1 of said heater rod are judiciously chosen.

In relation with FIG. 1, two resistances 4 are mounted in the casing 1 and are connected electrically in series. To do this, a non-heating jumper 7a made of conductive material is connected to each of the ends of the resistances 4 intended to be placed opposite the end 2 during the arrangement of said resistances in the casing 1, in order to electrically couple the heating wires of said resistances.

According to an embodiment not shown, several resistances 4, in particular several pairs of resistances 4, can be mounted in the casing by being connected electrically in parallel to each of the ends of a non-heating jumper 7a.

Furthermore, in FIG. 1, each heating wire is electrically connected to the connector 3 by means of a non-heating wire 7b made of a conductive material and projecting from the casing 1, these non-heating wires 7b allowing an electrical current to be transported between the connector 3 and the heating wires.

In particular, the non-heating wires 7b extend at least partially inside the connector 3, in such a way as to form with said connector a non-heated portion of the heater rod. Furthermore, the non-heating wires 7b can be connected to a connection conductor 8 or to a terminal 9 for electrical connection.

1-9. (canceled)

10. A heater rod comprising a casing wherein at least one electrical resistance heating element is mounted, an internal insulator being placed in the casing in order to ensure thermal conduction and electrical insulation between at least one electrical resistance and said casing, said at least one electrical resistance being formed from at least one heating wire which has a helical geometry, and the internal insulator having a boron nitride base.

11. The heater rod according to claim 10, wherein the internal insulator has the form of pellets of compressed boron nitride.

12. The heater rod according to claim 10, further comprising an insulating insert around which the helicoid of the at least one heating wire extends.

13. The heater rod according to claim 12, wherein the insulating insert is made from a material base which is different from that of the internal insulator.

14. The heater rod according to claim 12, wherein the insulating insert is made from a ceramic or magnesia base.

15. The heater rod according to claim 10, wherein said at least one electrical resistance comprises two electrical resistances mounted in the casing by being connected electrically in series.

16. The heater rod according to claim 10, wherein the at least one heating wire of the at least one electrical resistance is connected electrically to a connector projecting from the casing by means of a non-heating wire.

17. A method for carrying out a heater rod according to claim 10, comprising:
placing at least one electrical resistance heating element formed of at least one heating wire having a helical geometry in a casing;
placing an internal insulator with a boron nitride base in said casing; and
compacting the whole.

18. The method according to claim 17, wherein the at least one heating wire of the at least one electrical resistance is fitted as a helicoid around an insulating insert before being placed in the casing.
